(19) United States
(12) Patent Application Publication
(10) Pub. No.: US 2015/0026499 A1
(43) Pub. Date: Jan. 22, 2015

(54) CIRCUIT FOR CHANGING LOAD OPERATION USING TEMPORARY POWER-OFF MEANS

(71) Applicants: Chih-Ju HUANG, New Taipei City (TW); Chen-Hao CHANG, New Taipei City (TW)

(72) Inventor: Chih-Ju HUNG, New Taipei City (TW)

(21) Appl. No.: 13/945,248

(22) Filed: Jul. 18, 2013

(51) Int. Cl. G06F 1/32

(52) U.S. Cl. CPC G06F 1/3296
USPC 713/324

(57) ABSTRACT

A circuit for changing load operation using temporary power-off means having a power-off detection circuit with input end connected to a power source and its output end is connected to a microprocessor (MCU) connected to at least one load driving circuit. A load appliance is mounted on each of the load driving circuits. The microprocessor (MCU) has a program controlling each load appliance. During operation, the power is restored immediately after the power source is temporarily powered off, such that the power-off detection circuit detects a temporary turned-off signal and sends the signal to the microprocessor (MCU). Accordingly, the program to control each of the load appliances in the microprocessor (MCU) manipulates each load appliance for performing another operation or function.

### BACKGROUND OF THE INVENTION

1. Field of the Invention

The present invention relates to a circuit for changing load operation using temporary power-off means, particular to a circuit for manipulating the function of each load using temporary power-off means.

2. Description of Prior Art

Generally, an electronic appliance with remote control has a remote control signal receiving circuit for receiving a remote control signal to change the operation of the electronic appliance to a specific function according to the remote control signal.

Although it is convenient to use remote control to manipulate an electronic appliance, the remote control gets lost easily and needs to install the battery, which causes inconvenience.

### SUMMARY OF THE INVENTION

In view of the foregoing disadvantages in the art, the present invention is made based on the previous accumulated experiences and technology, through continuous research, experiments and improvement, to devise a new circuit for changing load operation using temporary power-off means to address the deficiency in the art.

It is an objective of the present invention to provide a circuit for changing the load operation using temporary power-off means to manipulate the function of each load with the temporary power-off means.

In accordance with the above objective, the present invention is provided with a power-off detection circuit which is connected to a microprocessor (MCU) and a power source. The microprocessor (MCU) is further connected to at least one load driving circuit. A load appliance is mounted on each of the load driving circuits. Also, a switch is provided between the power-off detection circuit and the power source. A program is installed in the microprocessor (MCU) for controlling each load appliance. During operation, the switch can be shortly turned on/off and the power is restored immediately after the power source is temporarily powered off, such that the power-off detection circuit can detect a temporary power-off signal and send the signal to the microprocessor (MCU). According to the signal, the program to control each of the load appliances in the microprocessor (MCU) manipulates each load appliance for performing another operation (function). Accordingly, a variety of operations/functions regarding remote control of each load appliance can be performed by temporarily turning on/off the switch.

The objective, shape, structure, characteristics, and efficacy of the present invention will become more apparent by describing in detail the embodiments thereof with reference to the attached drawings of which:

### BRIEF DESCRIPTION OF THE DRAWINGS

FIG. 1 shows a major circuit diagram according to the present invention;

FIG. 2 shows a power-off detection circuit according to the present invention;

FIG. 3 shows another power-off detection circuit according to the present invention;

FIG. 4 shows a circuit diagram of a power source according to the present invention;

FIG. 5 shows another circuit diagram of the power source according to the present invention;

FIG. 6 shows a load driving circuit diagram according to the present invention;

FIG. 7 is a flowchart showing the operation of the present invention.

### DETAILED DESCRIPTION OF THE PREFERRED EMBODIMENTS

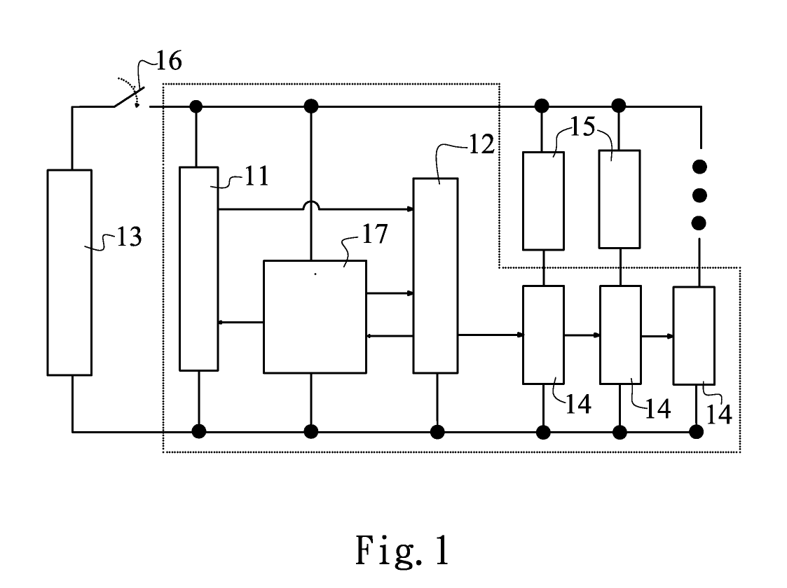

The present invention is directed to a “circuit for changing load operation using temporary power-off means”. Please refer to FIG. 1, which shows a power-off detection circuit 11 that is connected to a microprocessor (MCU) 12 and a power source 13 (DC or AC system power supply). The microprocessor (MCU) 12 is connected to at least one load driving circuit 14. A load appliance 15 (in the present invention, the load appliance may be bulbs, LED lanterns, electric curtains, fans, etc.) is mounted on each of the load driving circuits 14. Also, a switch 16 is provided between the power-off detection circuit 11 and the power source 13. The microprocessor (MCU) 12 has a program for controlling each of the load appliances.

During operation, the switch 16 can be temporarily turned on/off, such that the power source 13 can be restored immediately after temporary power-off and the power-off detection circuit 11 can detect a temporary power-off signal of the power source 13 and send the signal to the microprocessor (MCU) 12. According to the signal, the program for controlling each said load appliance 15 in the microprocessor (MCU) 12 controls each load appliance for performing another operation (function), for example, LED lights set from original monochrome display to multicolor marquee. Accordingly, various operations and functions regarding the remote control of each load appliance can be performed by temporarily turning on/off the switch.

Refer to FIG. 1 again, a built-in power supply circuit 17 is provided between the power-off detection circuit 11 and microprocessor (MCU) 12. The built-in power supply circuit 17 is connected to the power-off detection circuit 11 and the microprocessor (MCU) 12. When the switch 16 is shortly turned on/off, the power source 13 will be temporarily powered off and then powered on immediately, and the microprocessor (MCU) enters Low Power Consumption mode during power outage, while the built-in power supply circuit supplying power to the microprocessor (MCU) to keep it working normally.

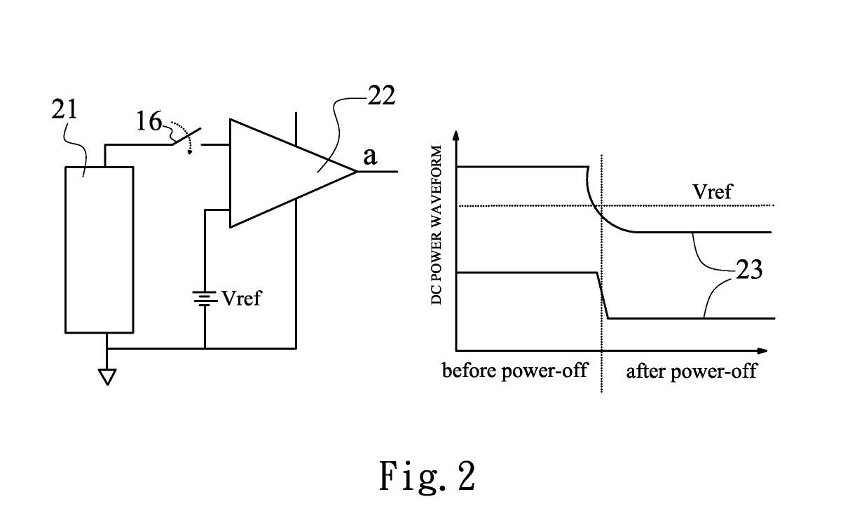

Please refer to FIGS. 1 and 2, where the power source 13 can be either a DC or AC system power supply. When served as a DC power source 21, the power-off detection circuit 11 may be a comparator 22 for detecting a waveform 23 after the DC system power supply 21 is powered off and sending the temporary power-off signal to the microprocessor (MCU) 12 based on the waveform 23, such that the microprocessor (MCU) 12 utilizes the program controlling each load appliance to manipulate each load appliance 15 to perform another operation (function) according to the temporary power-off signal. As shown in FIG. 2, before power-off, the waveform of the DC system power supply 21 is a high potential DC waveform; after power-off, the waveform changes to a no-potential waveform 23.

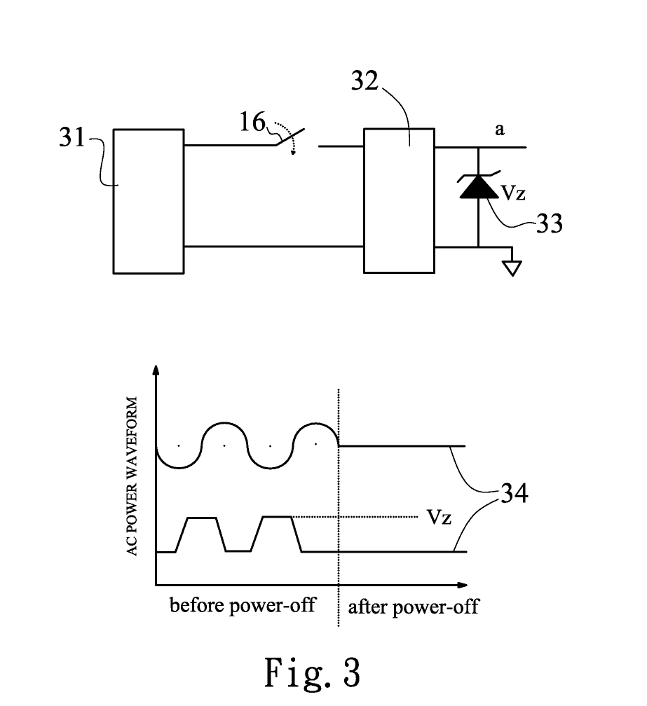

Please refer to FIGS. 1 and 3, where the power source 13 can be either a DC or AC system power supply. When served as an AC system power supply 31, the power-off detection circuit 11 can be a transformation element 32 which is connected in parallel with a zener diode 33 to detect the waveform 34 after the AC system power supply 31 is powered off and sends the temporary power-off signal to the microprocessor (MCU) 12 according to the waveform 34, such that the program for controlling each load appliance in the microprocessor (MCU) 12 manipulates each of the load appliances 15 to perform another operation (function). As shown in FIG. 3, before power-off, the waveform with regards to the AC system power supply 31 is a square waveform or a sinusoidal waveform; after power-off, the waveform changes to a no-potential waveform.

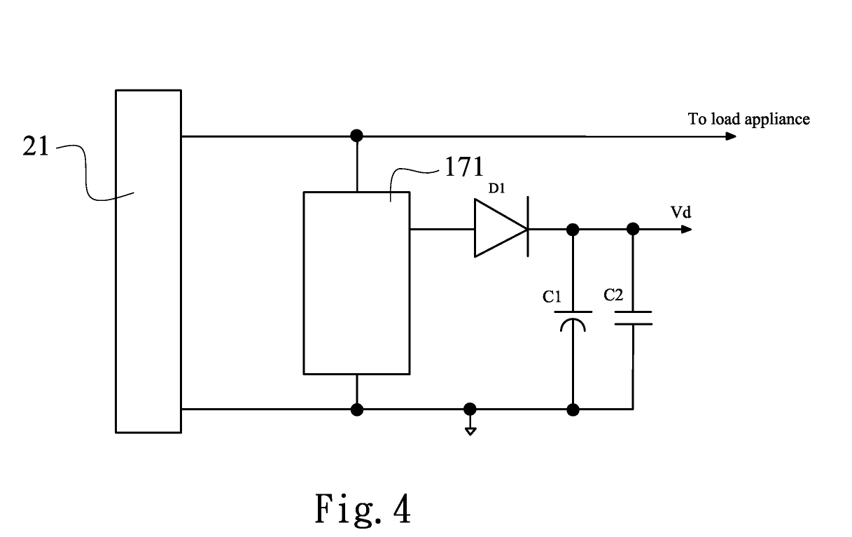

Please refer to FIGS. 1 and 4, where the power source 13 can be either a DC or AC system power supply. When served as a DC system power supply 21, the built-in power supply circuit 17 consists of a DC to AC converter 171 connected in series with a diode D1 and two capacitors C1, C2 connected in parallel. The two capacitors C1, C2 can store electrical energy before power-off. When the switch 16 is shortly turned on/off, the power source 13 will be temporarily powered off and then powered on immediately. During power outage, due to the unidirectional conduction characteristics of the diode, the two capacitors can provide the whole electricity stored before power-off to the microprocessor (MCU) to keep it working normally. Also, in the case that the two capacitors C1, C2 are supplied with power, the reverse power flow into the AC system power supply 31 can be avoided by using the diode D1 to limit the electricity of the two capacitors C1, C2 to flow into the microprocessor (MCU) 12 in one way, such that the microprocessor (MCU) 12 cannot be supplied with power.

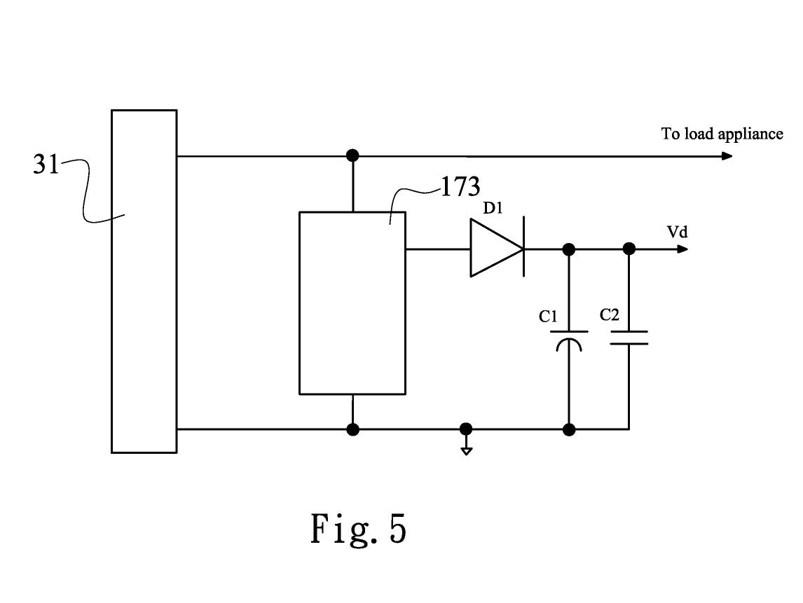

Please refer to FIGS. 1 and 5, where the power source 13 can be either a DC or AC system power supply. When served as an AC system power supply 31, the built-in power supply circuit 17 consists of an AC to DC converter 173 (connected in series with a diode D1 and connected in parallel with the two capacitors C1, C2. The two capacitors C1 and C2 can store electrical energy before power off. When the switch 16 is shortly turned on/off, the power source 1 will be temporarily powered off and then powered on immediately. During power outage, due to the unidirectional conduction characteristics of the diode, the two capacitors can provide the whole electricity stored before power-off to the microprocessor (MCU) to keep it working normally. Also, in the case that the two capacitors C1, C2 are supplied with power, through one-way limit by the diode D1 to limit the electricity of the two capacitors C1, C2 to flow into the microprocessor (MCU) 12 in one way, this can avoid the reverse power flow into the AC system power supply 31 such that the microprocessor (MCU) 12 cannot be supplied with power.

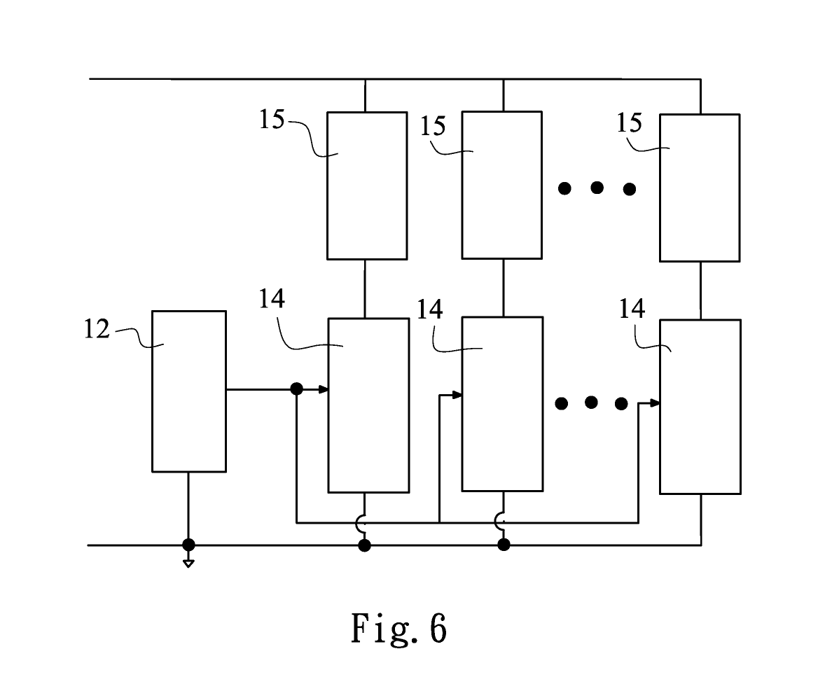

Please refer to FIGS. 1 and 6, there is one or a plurality of load driving circuits 14. A load appliance 15 is mounted on each of the load driving circuits 14. According to the temporary power-off signal, the program to control each load appliance in the microprocessor (MCU) 12 manipulates each load appliance 15 to perform another operation (function). Accordingly, various operations or functions regarding the remote control of each load appliance can be performed by temporarily turning on/off the switch 16.

Refer to FIGS. 1 and 6 again, when the load appliance 15 is a LED light set, the load driving circuit 14 is RELAY, BJT, or MOS; when the load appliance 15 is an impedance load(e.g. incandescent light bulbs, electric resistance), the load driving circuit 14 is RELAY, SCR, or TRIAC; when the load appliance 15 is a fluorescent lamp, the load driving circuit 14 is fluorescent lamp ballast (including electronic switch); when the load appliance 15 is a motor, the load driving circuit 14 is a motor drive circuit (including electronic switch).

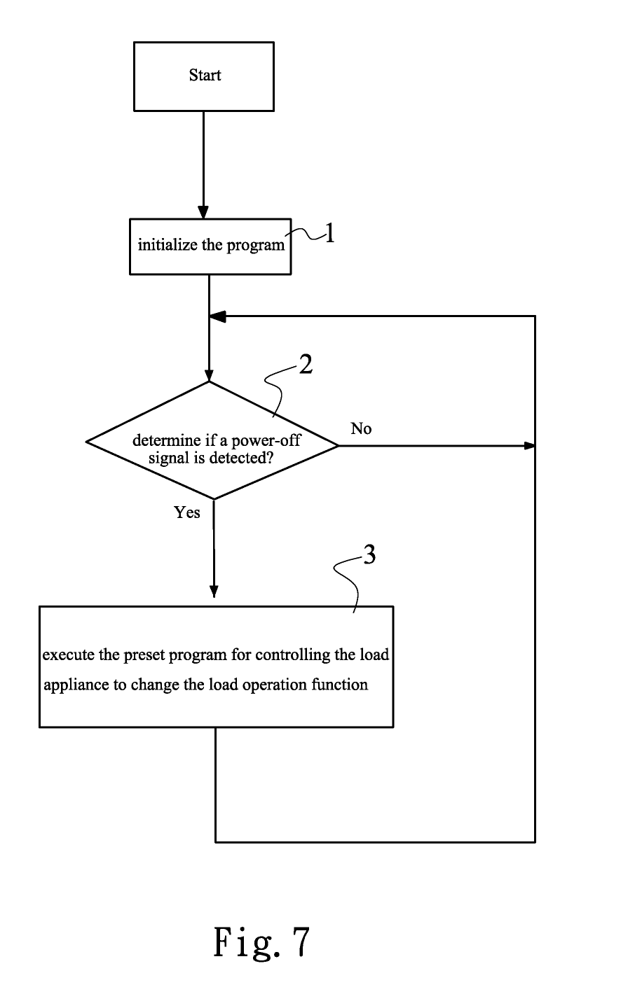

Please refer to FIG. 7, when the switch 16 is shortly turned on/off for various operations/functions regarding remote control of each load appliance, the microprocessor (MCU) 12 is processed according to the following steps:

First, initialize the program.

Then, determine if a power-off signal is detected? If yes, proceed with step (3); otherwise, perform step (2).

Next, execute the preset program for controlling the load appliance 15 to change the load operation function; then perform step (2).

As described above, the circuit for changing load operation using temporary power-off means in the present invention indeed has an unprecedented innovation structure and is not made in public, and thus has novelty without doubts. Also, the present invention has the unique feature and function that is different from the conventional technology, and thus is compliable with the provisions of the Patent Law. Accordingly, the patent application is filed.

What described above are for illustrating the preferred embodiments of the present invention, not for limiting the structure and features of the present invention. Any person skilled in the art shall be able to make modifications and changes to the embodiments without departing from the spirit of the present invention.

What is claimed is:

1. A circuit for changing load operation using temporary power-off means, which is provided with a power-off detection circuit, and is characterized in: an input end of the power-off detection circuit is connected to a power source for power supply, and a output end of the power-off detection circuit is connected to a microprocessor (MCU), the microprocessor (MCU) being connected to at least one load driving circuit, a load appliance being mounted on each of the load driving circuits; a switch being provided between the power-off detection circuit and the power source; the microprocessor (MCU) having a program for controlling each load appliance; through shortly turning on/off the switch, the power of the power source being restored immediately after power-off, such that the power-off detection circuit detecting a temporary power-off signal of the power source and sending the signal to the microprocessor (MCU) for the program to control each load appliance in the microprocessor (MCU) according to the signal to manipulate each load appliance to perform another operation or function.

2. The circuit for changing load operation using temporary power-off means as claimed in claim 1, wherein a built-in power supply circuit is provided between the power-off detection circuit and the microprocessor (MCU), the built-in power supply circuit being connected to the power-off detection circuit and the microprocessor (MCU); when the switch being shortly turned on/off, the power source being restored immediately after power-off, the microprocessor (MCU) entering low power consumption mode during power outage, while the built-in power supply circuit supplying power to the microprocessor (MCU) to keep it working normally.

3. The circuit for changing load operation using temporary power-off means as claimed in claim 2, wherein the power source is a DC system power supply.

4. The circuit for changing load operation using temporary power-off means as claimed in claim 3, wherein the power-off detection circuit is a comparator for detecting the waveform after the DC system power supply is powered off, and sends the temporary power-off signal based on the waveform to the microprocessor (MCU), such that the program for controlling each load appliance in the microprocessor (MCU) manipulates each load appliance according to the signal to perform another operation or function.

5. The circuit for changing load operation using temporary power-off means as claimed in claim 3, wherein the built-in power supply circuit consists of an DC to AC converter connected in series with a diode and two capacitors connected in parallel, the two capacitors storing electrical energy before power-off; when the switch being shortly turned on/off, the power source being temporarily powered off and then powered on immediately; during power outage, due to unidirectional conduction characteristics of the diode, the two capacitors providing the whole electricity stored before power-off to the microprocessor (MCU) to keep it working normally.

6. The circuit for changing load operation using temporary power-off means as claimed in claim 2, wherein the power source is an AC system power supply.

7. The circuit for changing load operation using temporary power-off means as claimed in claim 6, wherein the power-off detection circuit is a transformation element connected in parallel with a zener diode to detect the waveform after the AC system power supply is powered off, and sends a temporary power-off signal based on the waveform to the microprocessor (MCU) such that according to the signal the program to control each load appliance in the microprocessor (MCU) manipulates each load appliance to manipulate each load appliance to perform another operation (function).

8. The circuit for changing load operation using temporary power-off means as claimed in claim 6, wherein the built-in power supply circuit consists of an AC to DC converter connected in series with a diode and two capacitors connected in parallel, the two capacitors capable of restoring electrical energy before power-off;
when the switch is temporarily turned on/off, the power source restores power immediately after temporary power-off; during power outage, due to unidirectional conduction characteristics of the diode, the two capacitors provide the whole electrical energy restored before power-off to the microprocessor (MCU) to keep it working normally.
